(19) United States
(12) Patent Application Publication
(10) Pub. No.: US 2023/0159085 A1
(43) Pub. Date: May 25, 2023

(54) DRIVE FOR A STEERING AXLE OF AN INDUSTRIAL TRUCK, STEERING AXLE, AND INDUSTRIAL TRUCK

(71) Applicant: ZF Friedrichshafen AG, Friedrichshafen (DE)

(72) Inventors: Christian Stammberger, Vilshofen (DE); Max Leitner, Immenstaad (DE)

(73) Assignee: ZF Friedrichshafen AG, Friedrichshafen (DE)

(21) Appl. No.: 18/056,000

(22) Filed: Nov. 16, 2022

(30) Foreign Application Priority Data
Nov. 22, 2021 (DE) 10 2021 213 069.0

(51) Int. Cl. B62D 5/04; B62D 3/02

(52) U.S. Cl. CPC B62D 5/0412; B62D 3/02

(57) ABSTRACT

A drive (1) for a steering axle (26) of an industrial truck includes two steering arms (11, 12), an axle arch (8), a tie rod (13) configured as a spindle (13), a spindle nut (7) fixed axially on the tie rod (13), and a gear stage (21). Adjustment of the steering arms (11, 12) can be effected by axial displacement of the tie rod (13), and by the spindle nut (7) being able to be driven by a drive output element (7) of the gear stage (21). The drive (1) has two mutually coaxial electric motors (17, 18) disposed parallel to the tie rod (13). A drive element (14) of the gear stage (21) can be driven by the two electric motors (17, 18), which are disposed so as to be axially centric between the two electric motors (17, 18). Also disclosed is a steering axle and an industrial truck.

### RELATED APPLICATIONS

This application claims the benefit of and right of priority under 35 U.S.C. § 119 to German Patent Application no. 10 2021 213 069.0, filed on 22 Nov. 2021, the contents of which are incorporated herein by reference in its entirety.

### FIELD OF THE DISCLOSURE

The invention relates to a drive for a steering axle of an industrial truck, to a corresponding steering axle, and to a corresponding industrial truck.

### BACKGROUND

Industrial trucks which are configured as so-called three-wheel forklift trucks as well as so-called four-wheel forklift trucks are known in the prior art. Three-wheel forklift trucks in some instances have two non-driven wheels at the front and a drivable and steerable single wheel at the rear. However, the configuration with two drivable front wheels and a steerable rear wheel is more common, said rear wheel often being embodied as a double wheel. In contrast, in the case of four-wheel forklift trucks, the front wheels are always driven and the rear axle is steerable.

A typical requirement of all types of forklift truck steering systems is that of ideally large steering angle ranges which typically comprise steering angles of approx. −90° to +90°, 0° representing the straight-ahead position of the steering.

In the known industrial trucks, a steering angle range of this size is achieved only by a hydraulically activatable steering axle in which the actuator is correspondingly configured as a hydraulic cylinder.

As opposed thereto, electric steering axles, which are likewise known, do have a higher efficiency, do not require any hydraulic lines and are more easily actuatable than hydraulic steering systems. However, said electric steering axles in comparison to hydraulically activatable steering axles have a comparatively lower output density so that comparatively more installation space is required for the electric drive and for a corresponding hydraulic cylinder.

DE 10 2009 002 934 A1 shows an electrically activated steering axle for a commercial vehicle, in which a spindle is movable in the axial direction by a spindle nut which his disposed in the center of the axle. The spindle nut, by way of a gearbox, is driven by an electric motor which in terms of the center of the vehicle is disposed on one side of the spindle nut. The installation space required by the motor and the gearbox here is non-symmetrical in terms of the center of the vehicle. Therefore, the installation space particularly required for the motor may limit the steering angle position of the wheels.

DE 10 2009 002 935 A1 shows a similar steering gear. The spindle nut here is however driven by an electric motor which has a planetary gear and is disposed so as to be coaxial with the spindle nut. The spindle nut, the planetary gear and the electric motor form a relatively long functional group which restricts the maximum possible axial displacement path of the spindle in comparison to DE 10 2009 002 934 A1.

EP 2 569 205 B1 describes a steering axle in which the spindle nut, by way of a worm gear, is driven by an electric motor that stands so as to be perpendicular on the axis of the spindle nut. The drive can be disposed so as to be centric in relation to the vehicle axis; however, the electric motor by virtue of the position thereof significantly enlarges the installation dimensions of the steering axle.

EP 3 250 441 B1 discloses a steering axle in which the linearly movable element is a rack that is driven by a pinion, the latter representing the drive output of a three-stage spur wheel gear, the two first stages thereof being disposed above the central plane and the third stage thereof being disposed below the central plane. The required installation space is also disadvantageous in the case of this solution.

DE 10 2017 222 887 A1 finally describes a steering axle in which the axially movable part is a rack. The latter is driven by a drive unit which is fixedly fastened in the vehicle frame. While the steering axle can be embodied as a swing axle, the drive unit is stationary in the vehicle frame.

### SUMMARY

The known electrically actuatable steering axles are however disadvantageous in that they, by virtue of the required installation space of the drive thereof, or the disposal of the drive thereof, respectively, restrict the steering angle range of the steerable wheels.

It is an object of the present invention to propose an improved drive for a steering axle of an industrial truck.

This object is achieved according to the invention by the drive for a steering axle of an industrial truck, as disclosed herein. Advantageous design embodiments and refinements of the invention are derived from the present disclosure.

The invention relates to a drive for a steering axle of an industrial truck, comprising two steering arms, an axle arch, a tie rod configured as a spindle, a spindle nut fixed axially on the tie rod, and a gear stage, an adjustment of the steering arms being able to be effected by an axial displacement of the tie rod, and the spindle nut being able to be driven by a drive output element of the gear stage. The drive according to the invention is distinguished in that two mutually coaxial electric motors are disposed so as to be parallel to the tie rod, a drive element of the gear stage that is able to be driven by the two electric motors being disposed so as to be axially centric between the two electric motors.

The invention thus describes an electric drive which is suitable for use for a steering axle of an industrial truck. As has been described, steering axles for industrial trucks generally have to cover a very large steering angle range, whereby the wheel track of a steering axle of this type at the same time is relatively small. Moreover, the steering angles of the two wheels are not identical, the wheel axes generally thus not being parallel. Rather, the wheel axes ideally intersect in a point which lies on the geometrical axis of the front wheels. As is known, the steering angle of 0°, which corresponds to straight-ahead travel, is an exception. All wheel axes are at least approximately parallel in this steering position. The components of the steering axle and of the actuator herein should not get in the way of the wheels of the steering axle in any steering angle position and in this way restrict the steering angle.

The drive according to the invention comprises two steering arms by means of which the steerable wheels of the steering axle can be linked. Furthermore, the drive comprises a tie rod which, at least in the axially central region of the tie rod, has an external thread and in this way can be utilized as a spindle of a spindle drive. The drive also comprises a spindle nut which is disposed on the tie rod, or on the spindle, respectively, and can axially move the latter by a rotating movement of the spindle nut. The spindle nut is axially fixed, for example by a corresponding mounting. The drive furthermore comprises an axle arch, two electric motors and a gear stage, the axle arch advantageously supporting the other components of the drive, or serving the purpose of the other components of the drive being able to be disposed on the axle arch, respectively.

The gear stage is advantageously configured as a reduction stage and provided for transmitting a torque and a rotating speed from the two electric motors to the spindle nut. In this way, a rotating movement, specifically the rotating speed of the two electric motors, or of the gear stage, respectively, is ultimately converted into a linear movement of the tie rod.

It is now provided according to the invention that the two electric motors are disposed so as to be parallel to the tie rod and mutually coaxial. The two electric motors thus have a common axis which is parallel to the axis of the tie rod. The drive element of the gear stage, which is drivable by the two electric motors, is disposed so as to be axially centric between the two electric motors.

It is preferably provided that the two electric motors are disposed symmetrically about a central axis of the axle arch. In this way, none of the steerable wheels is restricted in terms of the steering angle range thereof by a non-symmetrical disposal of an electric motor, as is often customary in the prior art. This is furthermore also facilitated by the drive element of the gear stage that is disposed between the electric motors and thus on the central axis of the axle arch, said drive element accordingly transmitting the drive output in an axially centrical manner to the drive output element. As a result of this symmetry, the available installation space is utilized in a largely optimal manner.

This thus results in the advantage that the two electric motors are disposed so as to be spaced apart from the steerable wheels of the steering axle in such a manner that the steerable wheels in terms of the steering angle range thereof are not restricted by the two electric motors in any case. The steering angle range of a steering axle having the drive according to the invention is correspondingly larger than the steering angle range of known steering axles of the generic type.

The spindle nut is preferably also disposed so as to be axially centric on the tie rod.

According to one preferred embodiment of the invention it is provided that the spindle nut, the gear stage and the two electric motors are encased by a common housing. The housing herein advantageously holds the spindle nut, the gear stage and the two electric motors in their envisaged positions, in particular while axially supporting the spindle nut. The housing can furthermore receive mountings by way of which the spindle nut, the gear stage, and optionally the electric motors or motor shafts of the electric motors, respectively, are mounted, in particular rotatably mounted.

The housing is advantageously fixedly disposed on the axle arch and thus guarantees indirectly the disposal of the components encased by the housing in a desired position and alignment in relation to the axle arch.

The housing moreover fulfills a protective function in that said housing protects the encased components in relation to contamination, moisture and other corrosive substances.

According to one further preferred embodiment of the invention it is provided that the two electric motors have a common motor shaft, and the drive element of the gear stage is disposed so as to be axially centric and rotationally fixed on the common motor shaft. The two electric motors having a common motor shaft means that said electric motors are connected to one another in a very robust and mechanically load bearing manner. Moreover, the assembly of the drive is simplified because the two electric motors can be assembled on the drive like a single component and in particular do not have to be mutually aligned. The coaxial alignment of the two electric motors is established from the outset as a result of the common motor shaft.

Moreover, in the absence of an interface between the two electric motors in operation, the two electric motors are always completely synchronized, and differences in terms of the rotating speed or torque, respectively, cannot arise.

Since the drive element is disposed so as to be axially centric and rotationally fixed on the common motor shaft, said drive element is disposed so as to be directly adjacent to the two electric motors. Bending moments or other undesirable elastic effects of the motor shaft are largely precluded or reduced, respectively. The drive element is uniformly driven by both electric motors.

According to one particularly preferred embodiment of the invention it is provided that the common motor shaft by way of mountings is rotatably mounted axially between the two electric motors or axially outside the two electric motors. Both embodiments stabilize the common motor shaft, improve the constant velocity of the motor shaft and enable the shaft to be firmly supported.

The common motor shaft is further stabilized, and deformations are even further reduced even under high loads, in particular when the mountings are disposed so as to be axially between the two electric motors. Above all, deformations as a result of forces of the teeth or the belts of the gear stage can be reduced.

According to one alternatively preferred embodiment of the invention, it is provided that the two electric motors have two motor shafts, the two motor shafts being connected in a rotationally fixed manner to one another by a coupling, and the drive element of the gear stage being disposed so as to be rotationally fixed on the coupling. In this way, two commercially available electric motors, advantageously of an identical construction, can be utilized for the drive according to the invention. The coupling which connects in a rotationally fixed manner the two motor shafts to one another absorbs and equalizes differences in terms of rotating speed or torque between the two electric motors, respectively. The rotationally fixed connection can be established, for example, by way of splined connections or similar form-fitting connections.

According to one particularly preferred embodiment of the invention, it is provided that the coupling is rotatably mounted in the housing by way of mountings, the coupling representing the drive element. In that the coupling is mounted directly in the housing, forces acting on the coupling can be effectively discharged into the housing. This is particularly advantageous because the coupling moreover represents the drive element of the gear stage and all forces or torques, respectively, that are generated by the two electric motors are routed by way of the coupling. For example, the coupling may have an external toothing.

According to one further preferred embodiment of the invention, it is provided that the gear stage is configured as a spur wheel stage, the spindle nut having an external toothing which represents the drive output element. In this way, the drive output element is thus a component part of the spindle nut, and the spindle nut can accordingly be utilized as a component part of the gear stage. In this way, an additional component as a drive element is advantageously dispensed with. As a result, the drive is compact, lightweight and cost-effective.

To the extent that the coupling is utilized as a drive element, said coupling advantageously likewise has an external toothing by way of which said coupling meshes with the external toothing of the spindle nut.

According to one further preferred embodiment of the invention, it is provided that the gear stage is configured as a traction mechanism, the spindle nut having an external running face which represents the drive output element. In this case, the drive element in this way is thus likewise a component part of the spindle nut, and the spindle nut here too can be utilized as a component part of the gear stage. For example, the traction mechanism can be configured as a timing belt drive. In this instance, the spindle nut on the external running face thereof advantageously has grooves in which the teeth of the timing belt can engage. Since the spindle nut in this case is also utilized directly as the drive output element of the gear stage, no additional component has to accordingly be provided as an output drive element. A compact, lightweight and cost-effective drive can thus also be provided in this case.

To the extent that the coupling is again utilized as a drive element, said coupling on the external circumference thereof likewise advantageously has grooves in which the teeth of the timing belt can engage.

The invention furthermore relates to a steering axle for an industrial truck, comprising two steerable wheels and a drive for the steering axle. The drive is configured as a drive according to the invention. As a result, the advantages which have already been mentioned in the context of the drive according to the invention are also derived for the industrial truck according to the invention.

According to one preferred embodiment of the invention, it is provided that the two electric motors are disposed at the height level of the axle arch and behind the axle arch in the travel direction of the steering axle. This thus means that a longitudinal axis through the two electric motors and a longitudinal axis through the axle arch lie in a common plane, the common plane being parallel to a hard surface on which the steering axle is able to be moved. As a result of this assembly it is guaranteed, on the one hand, that there is sufficient ground clearance available below the steering axle, and no additional installation space is required above the steering axle, on the other hand. In that the two electric motors are moreover disposed behind the axle arch in the travel direction of the steering axle, the potential steering angle ranges of the steerable wheels are also not restricted.

The invention furthermore relates to an industrial truck, comprising a steering axle according to the invention. As a result, the advantages which have already been mentioned in the context of the steering axle according to the invention are also derived for the industrial truck according to the invention.

### BRIEF DESCRIPTION OF THE DRAWINGS

The invention will be explained in an exemplary manner hereunder by means of embodiments illustrated in the figures.

In the figures:

FIG. 1 shows in an exemplary and schematic manner a potential embodiment of a steering axle according to the invention, having a drive according to the invention, in a plan view from above;

FIG. 2 shows the steering axle of FIG. 1, having a maximum steering angle toward the right;

FIG. 3 shows in an exemplary and schematic manner a further potential embodiment of a steering axle according to the invention, having a drive according to the invention in the steering angle position already shown in FIG. 2; and

FIG. 4 shows in an exemplary and schematic manner a further potential embodiment of a steering axle according to the invention, having a drive according to the invention in the steering angle position already shown in FIG. 2.

Identical items, functional units and equivalent components are provided with the same reference signs in all of the figures. These items, functional units and equivalent components are identically embodied in terms of the technical features thereof, unless otherwise explicitly or implicitly derived from the description.

### DETAILED DESCRIPTION

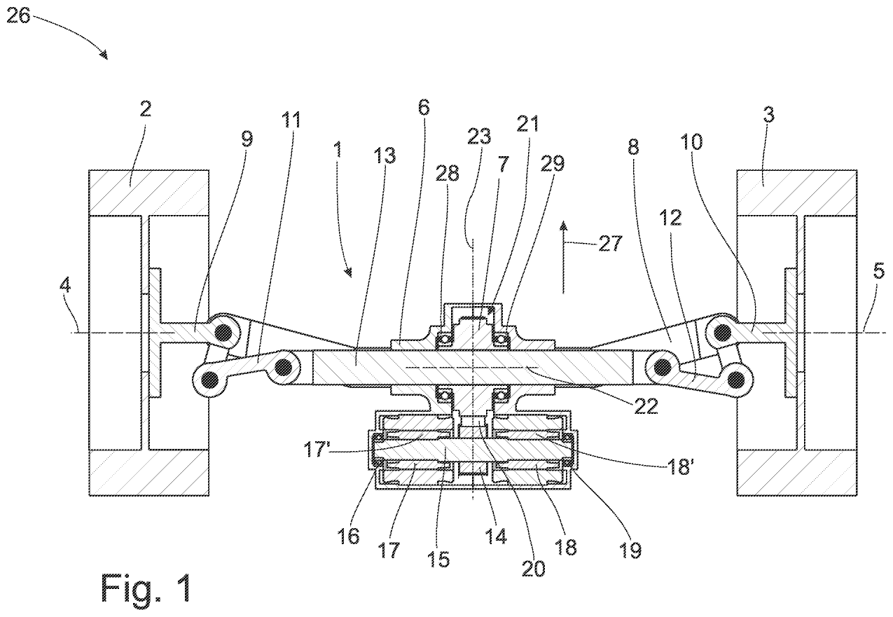

FIG. 1 shows in an exemplary and schematic manner a potential embodiment of a steering axle 26 according to the invention, having a drive 1 according to the invention, in a plan view from above. The steering axle 26 is provided for use in an industrial truck (not illustrated in FIG. 1). The steering axle 26 comprises two steering arms 11 and 12, an axle arch 8, a tie rod 13 configured as a spindle 13, a spindle nut 7 fixed axially on the tie rod 13, and a gear stage 21. The gear stage 21 comprises a drive element 14, which is configured as a drive wheel 14 for a belt drive, and the spindle nut 7 which according to the example by way of a corresponding external running face is configured as a drive output element 7 for the belt drive and by way of a timing belt 20 is operatively connected to the drive element 14 configured as the drive wheel 14. The steering axle 26 furthermore comprises two mutually coaxial electric motors 17 and 18 which are aligned so as to be parallel to the tie rod 13. Finally, the steering axle 26 also comprises a common housing 6 which is fixedly disposed on the axle arch 8 and encases the two electric motors 17, 18 and the gear stage 21, mounting in each case the two electric motors 17, 18 and the gear stage 21 by way of mountings 28, 29, 16 and 19.

As can be seen in FIG. 1, the steerable wheels 2 and 3 according to the example are not turned. Accordingly, their axes 4 and 5 are mutually parallel or identical, respectively. The housing 6 receives the spindle nut 7 in such a manner that the spindle nut 7 is mounted in the housing 6 so as to be rotatable about the axis 22 but is immovable in the axial direction. A rotating movement of the spindle nut 7 is converted into an axial movement of the spindle 13, the latter transmitting the movement to the steering arms 11 and 12 and thus to the axle journals 9 and 10 that are rotatably mounted in the axle body 8. The wheels 2 and 3, which are mounted so as to be rotatable about the axes 4 and 5, are fastened to the axle journals 9 and 10 and are pivoted conjointly with the latter. The spindle nut 7 as the drive output element 7 of the gear stage 21 is driven, the latter being configured according to the example as a traction mechanism 21.

The two electric motors 17 and 18 have a common motor shaft 15, the drive element 14 being disposed so as to be a rotationally fixed in the axial center between said two electric motors 17 and 18. The motor shaft 15 by way of the mountings 16 and 19 is rotatably mounted in the housing 6. The electric motors 17, 18 per se are in each case held so as to be rotationally fixed in the housing 6. Moreover, the motor shaft 15 supports the rotors 17′ and 18′ of the electric motors 17 and 18. The electric motors 17 and 18 are disposed so as to be symmetrical in relation to the central axis 23 of the industrial truck not illustrated. The drive element 14 is disposed so as to be centric between the rotors 17′ and 18′.

The travel direction of the steering axle 26 here is illustrated by an arrow 27 in FIG. 1. The two electric motors 17 and 18 in the travel direction of the steering axle 26 are disposed at the same height level as the axle arch 8, so as to be behind the axle arch 8.

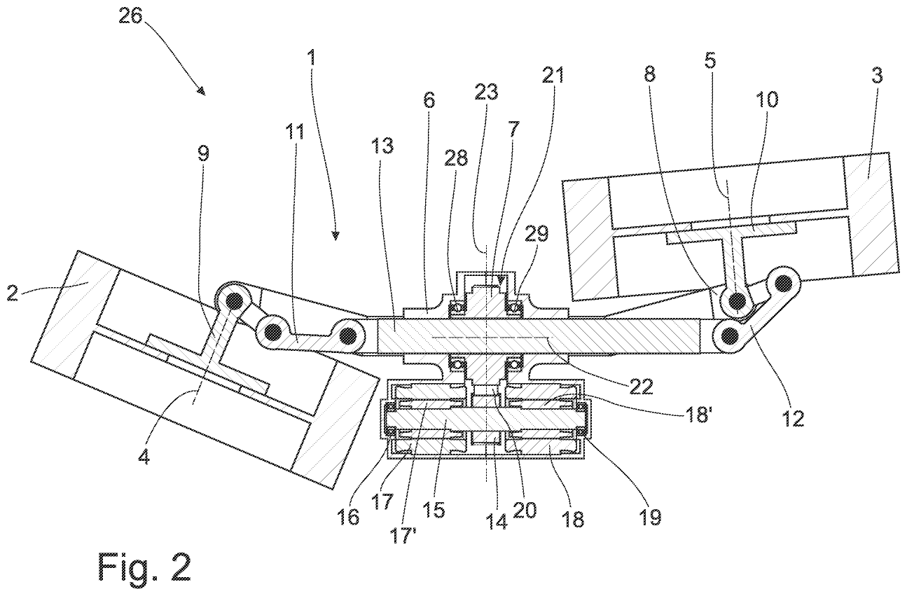

FIG. 2 shows the steering axle 26 of FIG. 1, having a maximum steering angle toward the right. FIG. 2 visualizes that the installation space available for the drive 1 is very limited, in as far as said drive 1 is not to restrict the steering angle range of the wheels 2 and 3. The available installation space here, without the latter restricting the steering angle range of the wheels 2 and 3, is delimited by an envelope of the movement of the wheels 2 and 3 (not illustrated in FIG. 2). The drive output required for steering is divided among the electric motors 17 and 18, the latter being in each case able to be embodied smaller than if only a single electric motor were to be used for the drive of the steering axle 26. The symmetrical disposal of the spindle nut 7 and of the electric motors 17 and 18 in relation to the central axis 23 of the steering axle 26 enables a maximum stroke of the spindle 13 in the spindle nut 7 toward the left or the right, respectively, without restricting the steering angle position of the wheels 2 and 3. The electric motors 17 and 18 utilize the available installation space to the optimum.

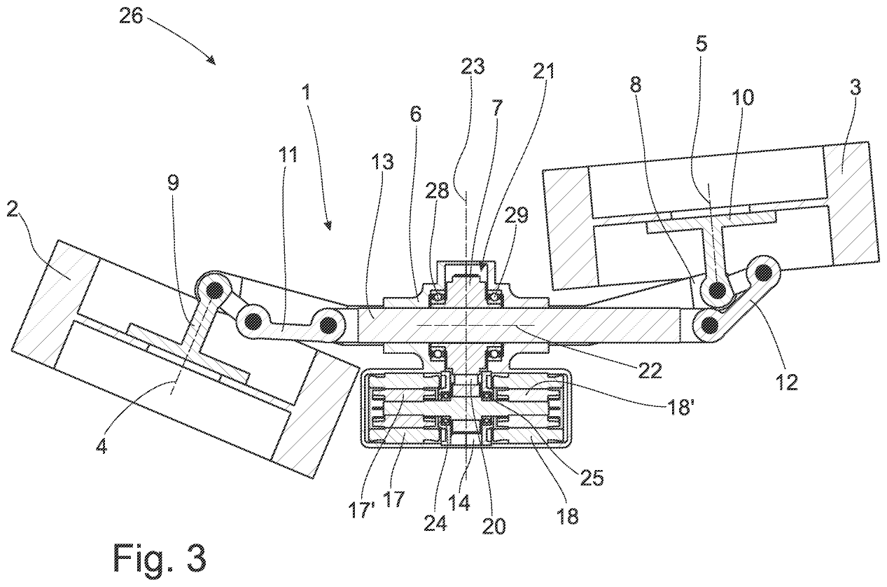

FIG. 3 shows in an exemplary and schematic manner a further potential embodiment of a steering axle 26 according to the invention, having a drive 1 according to the invention, in the steering angle position already shown in FIG. 2. The steering axle 26 illustrated in FIG. 3 differs from the steering axle of FIG. 2 or FIG. 1, respectively, in terms of the mounting of the motor shaft 15. Instead of mountings 16 and 19 at the axial ends of the motor shaft 15, the latter is rotatably mounted by mountings 24 and 25. The mountings 24 and 25 here are disposed on both sides on the motor shaft 15 so as to be directly adjacent to the drive element 14. In this way, forces of the teeth or the belts of the gear stage 21 can be reduced.

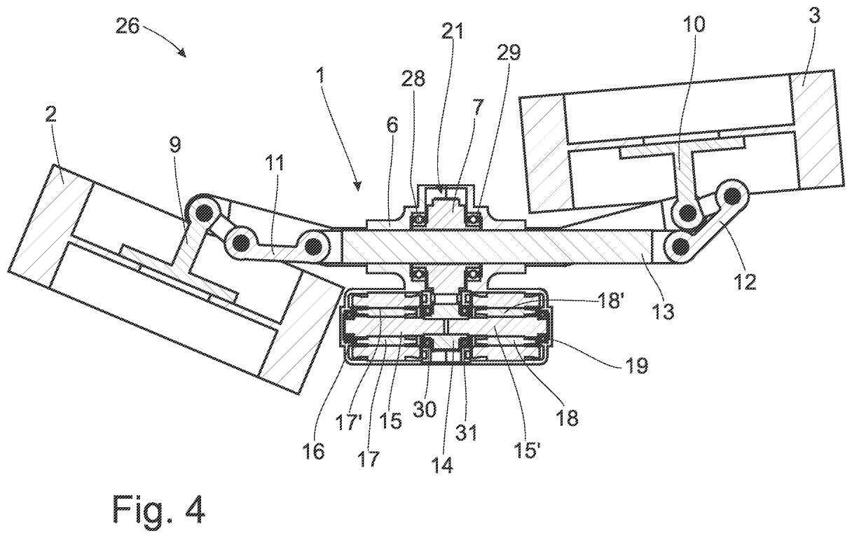

FIG. 4 shows in an exemplary and schematic manner a further potential embodiment of a steering axle 26 according to the invention, having a drive 1 according to the invention, in the steering angle position already shown in FIG. 2. The steering axle 26 of FIG. 4 here has two individual motor shafts 15, 15′. The motor shaft 15 is assigned to the electric motor 17, and the motor shaft 15′ is assigned to the electric motor 18. The motor shafts 15 and 15′ are connected in a rotationally fixed manner to the drive element 14, the latter being configured as a coupling 14 for the driveshafts 15, 15′. The motor shaft 15 transmits the drive output of the electric motor 17 to the drive element 14, and the motor shaft 15′ transmits the drive output of the electric motor 18 to the drive element 14. The drive element 14 with the aid of the mountings 30 and 31 is mounted in the housing 6 and receives the drive output-proximal ends of the motor shafts 15 and 15′. The motor shaft 15 on the side opposite the drive output side is mounted in the housing 6 with the aid of the mounting 16. The motor shaft 15′ on the side opposite the drive output side is mounted in the housing 6 with the aid of the mounting 19. This enables a comparatively easier assembly of the drive 1.

### LIST OF REFERENCE SIGNS

1 Drive
2 Steerable wheel
3 Steerable wheel
4 Axis
5 Axis
6 Housing
7 Spindle nut, drive output element
8 Axle arch
9 Axle journal
10 Axle journal
11 Steering arm
12 Steering arm
13 Tie rod, spindle
14 Drive element, coupling, drive wheel
15, 15′ Motor shaft
16 Mounting
17 Electric motor
17′ Rotor
18 Electric motor
18′ Rotor
19 Mounting
20 Timing belt
21 Gear stage, traction mechanism, spur wheel stage
22 Axis
23 Central axis
24 Mounting
25 Mounting
26 Steering axle
27 Arrow, travel direction
28 Mounting
29 Mounting
30 Mounting
31 Mounting

1. A drive (1) for a steering axle (26) of an industrial truck, comprising:
two steering arms (11, 12);
an axle arch (8);
a tie rod (13) configured as a spindle (13);
a spindle nut (7) fixed axially on the tie rod (13);
two mutually coaxial electric motors (17, 18) disposed parallel to the tie rod (13); and
a gear stage (21) having a drive element (14) configured to be driven by the two electric motors (17, 18), the gear stage being disposed axially centric between the two electric motors (17, 18);
wherein an adjustment of the two steering arms (11, 12) can be effected by an axial displacement of the tie rod (13), and by the spindle nut (7) being able to be driven by a drive output element (7) of the gear stage (21).

2. The drive (1) as claimed in claim 1, wherein the spindle nut (7), the gear stage (21), and the two electric motors (17, 18) are encased by a common housing (6).

3. The drive (1) as claimed in claim 1, wherein the two electric motors (17, 18) are disposed symmetrically about a central axis (23) of the axle arch (8).

4. The drive (1) as claimed in claim 1, wherein the two electric motors (17, 18) have a common motor shaft (15) and the drive element (14) of the gear stage (21) is disposed so as to be axially centric and rotationally fixed on the common motor shaft (15).

5. The drive (1) as claimed in claim 4, wherein the common motor shaft (15) by way of mountings (16, 19, 24, 25) is rotatably mounted so as to be axially between the two electric motors (17, 18) or axially outside the two electric motors (17, 18).

6. The drive (1) as claimed in claim 1, wherein the two electric motors (17, 18) have two motor shafts (15, 15′), the drive comprising a coupling (14) connecting the two motor shafts (15, 15′) in a rotationally fixed manner, and the drive element (14) of the gear stage (21) being disposed so as to be rotationally fixed on the coupling (14).

7. The drive (1) as claimed in claim 6, wherein the coupling (14) is rotatably mounted in the housing (6) by way of mountings (30, 31), the coupling (14) representing the drive element (14).

8. The drive (1) as claimed in claim 1, wherein the gear stage (21) is configured as a spur wheel stage (21), the spindle nut (7) having an external toothing which represents the drive output element (7).

9. The drive (1) as claimed in claim 1, wherein the gear stage (21) is configured as a traction mechanism (21), the spindle nut (7) having an external running face which represents the drive output element (7).

10. A steering axle (26) for an industrial truck, comprising:
two steerable wheels (2, 3); and
the drive (1) of claim 1 for the steering axle (26).

11. The steering axle (26) as claimed in claim 10, wherein the two electric motors (17, 18) are disposed at a height level of the axle arch (8) and behind the axle arch (8) in the travel direction of the steering axle (26).

12. An industrial truck, comprising a steering axle (26) as claimed in claim 10.

13. The drive (1) of claim 1, wherein the two electric motors (17, 18) are disposed symmetrically about the central axis (23) of the axle arch (8).

14. The drive (1) of claim 13, comprising:
first and second motor shafts (15, 15′);
a coupling (14) connecting the first and second motor shafts (15, 15′) in a rotationally fixed manner;
wherein the drive element (14) of the gear stage (21) is rotationally fixed on the coupling (14).

15. The drive (1) of claim 14, wherein the coupling (14) is rotatably mounted in the housing (6) by way of mountings (30, 31).

16. The drive (1) of claim 13, wherein the two electric motors (17, 18) have a common motor shaft (15) and the drive element (14) of the gear stage (21) is disposed so as to be axially centric and rotationally fixed on the common motor shaft (15).

17. The drive (1) of claim 16, wherein the common motor shaft (15) is rotatably mounted so as to be axially between the two electric motors (17, 18).

18. The drive (1) of claim 16, wherein the common motor shaft (15) is rotatably mounted so as to be axially outside the two electric motors (17, 18).

19. The drive (1) of claim 16, wherein the gear stage (21) is configured as a spur wheel stage (21).

20. The drive (1) of claim 16, wherein the gear stage (21) is configured as a traction mechanism (21).
